(19) United States
(12) Patent Application Publication
(10) Pub. No.: US 2002/0138759 A1
(43) Pub. Date: Sep. 26, 2002

(54) System and method for secure delivery of a parcel or document

(75) Inventor: Rabindranath Dutta, Austin, TX (US)

Correspondence Address: Paul D. Heydon, Patent Attorney, 6102 Broadway, Suite B2, San Antonio, TX, 78209, US

(73) Assignee: International Business Machines Corporation

(21) Appl. No.: 09/817,103

(22) Filed: Mar. 26, 2001

(51) Int. Cl. H04L 9/00

(52) U.S. Cl. 713/201

(57) ABSTRACT

The present invention is a system and method for secure delivery of a parcel or physical (hard copy) document. The invention uses a computer system and network, and may use public-key infrastructure (PKI), public-key cryptography and symmetric-key cryptography. The invention involves generating encryption keys, encrypting data, providing said encrypted data for display on an envelope, and decrypting the encrypted data. One aspect of the present invention is a method for secure delivery of a parcel or document. Another aspect of the present invention is a system for executing the method of the present invention. A third aspect of the present invention is as a set of instructions on a computer-usable medium, or resident in a computer system, for executing the method of the present invention.

### FIELD OF THE INVENTION

The present invention relates generally to secure delivery of a parcel or document, and more particularly to methods and systems using encrypted data for secure delivery of a parcel or document.

### BACKGROUND OF THE INVENTION

Delivery methods in use today involve making a recipient's address widely known to a number of possible senders, and incidentally to others who may make unwanted use of the address. Methods in use today also involve display of a recipient's and a sender's addresses on an envelope, in view of persons who may make unwanted use of the addresses. This situation may be inconsistent with the privacy or safety of recipient and sender. For example, consider a person's need to avoid visits from annoying or dangerous persons. Celebrities and judges have a well-known need for privacy and safety in this regard. Others have a strong desire for privacy, or a need for discrete communications in business, or a desire to avoid sales and marketing efforts directed at a person's physical address.

Thus there is a need for systems and methods that keep addresses secret, while at the same time providing delivery of a parcel or document from a sender to a recipient at a physical address.

### SUMMARY OF THE INVENTION

The present invention provides security and privacy benefits to both senders and recipients, while providing delivery of a parcel or physical document. The invention uses encryption to shield a recipient's address, or a sender's address, or both. The invention uses a computer system and network, and may use both public-key cryptography and symmetric-key cryptography. The invention involves generating encryption keys, encrypting data, providing the encrypted data for display on an envelope, and decrypting the encrypted data.

For example, rather than making a recipient's address widely available, the invention makes a recipient's address widely available only in encrypted form. The recipient's address in encrypted form is printed on the envelope. An unauthorized person will learn nothing about the recipient by looking at the envelope. The invention then allows a delivery agency to decrypt the address and deliver the parcel or document to a recipient at a physical address. As another example, the sender's address in encrypted form is printed on the envelope. An unauthorized person will learn nothing about the sender by looking at the envelope. The invention then allows a delivery agency to decrypt the address and inform the recipient of the sender's identity at the time of delivery.

To give a more detailed example, using public-key cryptography, a delivery agency using the present invention generates a private-public encryption key pair for a registered recipient. The agency encrypts the recipient's address with the public key of the key pair, and provides the encrypted address via the Internet for labeling an envelope. The agency, after picking up the envelope, routes the envelope by decrypting the encrypted address, using a computer system and the private key, of the key pair, to yield the recipient's address. Finally the agency delivers the envelope to the recipient.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 is a flow chart illustrating an example of a delivery process according to the teachings of the present invention.

FIG. 2 is a high-level block diagram illustrating an example of a system for secure delivery according to the teachings of the present invention.

FIG. 3 is a block diagram illustrating in greater detail selected features that may be included in an exemplary system such as the exemplary system of FIG. 2, according to the teachings of the present invention.

FIG. 4 is a flow chart illustrating in greater detail an exemplary process such as the exemplary process of FIG. 1, according to the teachings of the present invention.

FIG. 5 is a diagram illustrating two examples of envelopes that could be used in a delivery process according to the teachings of the present invention.

FIG. 6 is a flow chart illustrating an example of a delivery process involving encrypting data unique to a sender (sender's data) according to the teachings of the present invention.

FIG. 7 illustrates a simplified example of a computer system capable of performing the present invention.

### DETAILED DESCRIPTION

In providing secure delivery of a parcel or document, the invention uses encryption to shield a recipient's address, or a sender's address, or both. Encryption is a well-known solution to problems in other fields, but not in the field of delivering physical documents or parcels. The invention uses a computer system and network, and may use both public-key cryptography and symmetric-key cryptography. For an introduction to public-key cryptography, reference is made to the text Understanding Public-key Infrastructure: Concepts Standards and Deployment Considerations, by Carlisle Adams and Steve Lloyd, Macmillan Technical Publishing, Indianapolis, Ind., 1999. For details on topics such as key generation and signing, cryptographic hardware and software architectures, and description of public key algorithms, reference is made to The Open-source PKI Book: A guide to PKIs and Open-source Implementations, 2000 by Symeon (Simos) Xenitellis, available at http:/Hospkibook.sourceforge.net. Reference is made to documents describing Internet X.509 Public Key Infrastructure (PKIX) standards, such as ITU-T Recommendation X.509, available at ftp://ftp.Bull.com/pub/OSIdirectory/4thEditionTexts/.

The examples that follow involve the use of computers and a network. The present invention is not limited as to the type of computer on which it runs. To guide the envelope through routing and delivery, conventional scanner hardware and software are used to read the data displayed on the envelope. Examples are an automated label-reading process using a computer coupled with a scanner, or a person using a handheld computer coupled with a scanner.

To decrypt the encrypted data on the envelope to yield the recipient's address, a system is used to securely store private keys or symmetric keys, but allow access to the keys for use in decryption. Such hardware and software are well-known to those skilled in the art. For example, the system may retrieve a private key from a secure key database through a secure key manager module, and decrypt the encrypted data printed on an envelope. Another example is the use of an external security manager program provided by a third party that manages a secure key database.

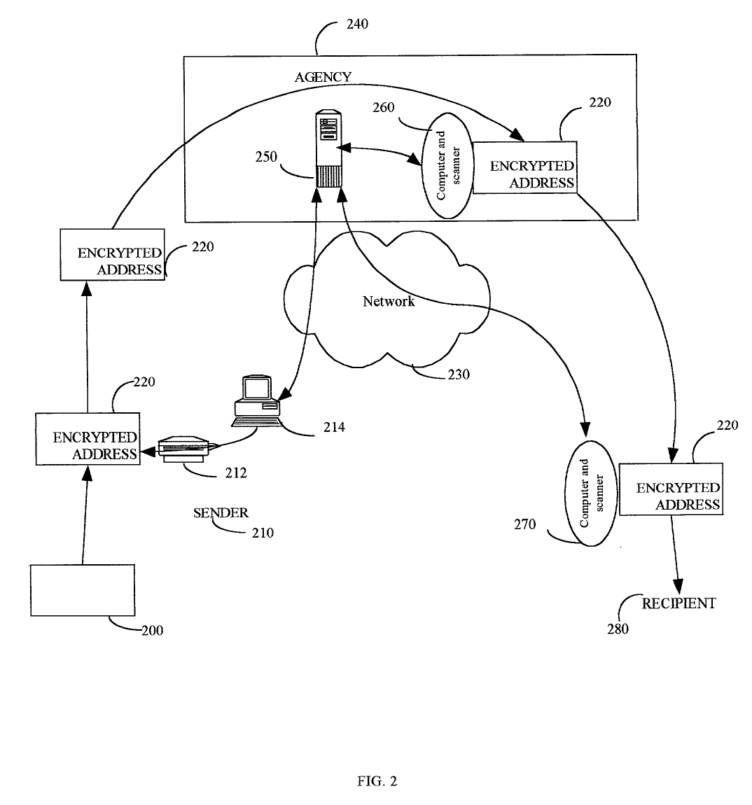

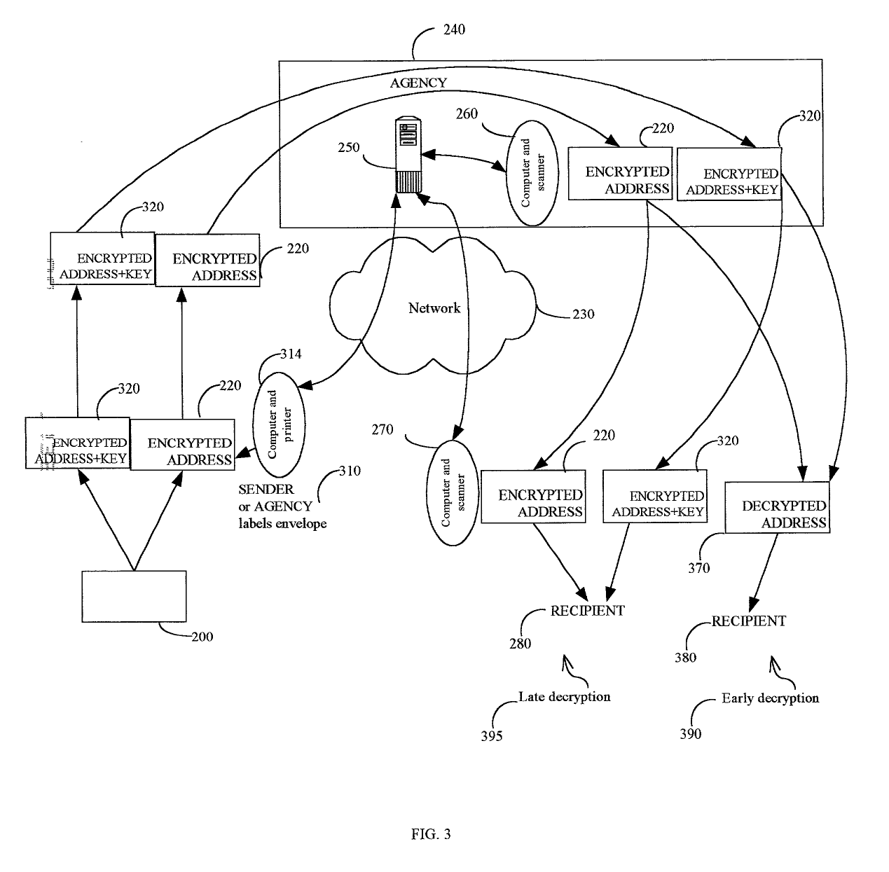

To simplify the diagrams, FIG. 2 and FIG. 3 show examples with only one server computer and one network. However, more than one server and more than one network may be used. For security reasons, it may be preferable to use one server for providing encrypted addresses via the Internet, and another server for providing access to private keys or symmetric keys for decryption, perhaps via a private network. Similarly, FIG. 2 and FIG. 3 show examples with only one server computer within the agency as a means for generating encryption keys, and a means for encrypting data, as well as a means for providing encrypted data for display on an envelope. However, it may be preferable to use separate computers for these separate functions. FIG. 2 and FIG. 3 are fully described below.

The following are definitions of terms used in the description of the present invention and in the claims:

“Agency” or “delivery agency” means any person or organization who delivers, or assists in delivering, documents or parcels; some examples are a courier service, delivery service, post office, or a provider of security services for delivery operations.

“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.

“Displaying” data, or data “displayed,” on an envelope means any printing of data directly on an envelope or on a label affixed to an envelope, where printing may be with conventional or magnetic ink, and may be readable by humans or by machine.

“Envelope” means any kind of physical wrapper or packaging for a parcel or document.

“Key” or “encryption key” means any string of bits used in cryptography, allowing people to encrypt and decrypt data.

“Plaintext” means original information, not encrypted.

“Private-public encryption key pair” means a pair of keys, one called the public key and the other called the private key, used in public-key cryptography.

“Private key” means a key that is kept secret, in public-key cryptography.

“Public key” means a key that may be published, or made available to all, in public-key cryptography.

“Symmetric encryption key,” also known as a secret key, means a single key that can be used to encrypt and decrypt a message.

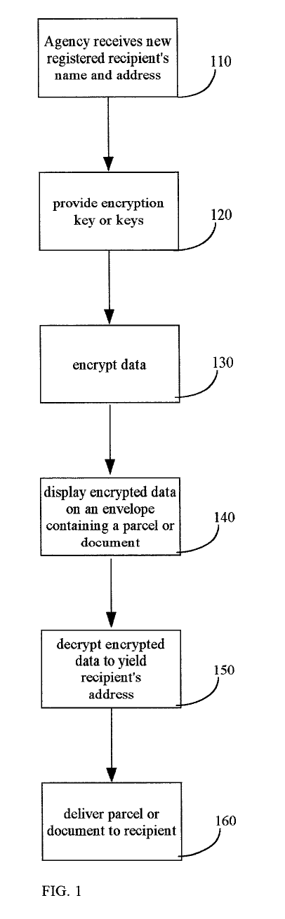

FIG. 1 is a flow chart illustrating an example of a delivery process according to the teachings of the present invention. In this example the process starts at 10 with a delivery agency receiving a new registered recipient's name and address. Next, at 120, the agency provides the encryption key or keys for the recipient. The key or keys are used to encrypt data for the recipient, 130. When a sender is ready to send a parcel or document to recipient, at 140 the encrypted data is displayed on the envelope, in place of the recipient's address in plaintext. This would be done at or before the time the agency takes possession of the envelope from the sender. To guide the envelope through routing and delivery, the agency decrypts the encrypted data to yield said recipient's address, 150, finally delivering said parcel or document to said recipient, 160.

FIG. 2 is a high-level block diagram illustrating an example of a system for secure delivery according to the teachings of the present invention. At the left side of FIG. 2, a sender 210 prepares a parcel or document 200 being sent to a recipient 280. Next, in this example, the encrypted address is displayed on envelope 220 by the sender 210. This could be accomplished as follows. The agency provides at least one server computer 250 in communication with a computer network 230. The agency provides at least one private-public encryption key pair (not shown) for said recipient 280. An alternative approach is providing at least one symmetric encryption key for said recipient 280, used for encryption and decryption. In this example, the agency encrypts data with a public key, of said private-public encryption key pair, and stores said encrypted address on said server 250. The sender 210 transmits a request for said encrypted address to said server 250 from a client computer 214, over said computer network 230. The agency 240 transmits said encrypted address from said server 250 to said client computer 214, over said computer network 230, for printing on a label with a printer 212. The encrypted address is displayed on the envelope 220 by putting the label on the envelope 220.

Next, the agency 240 takes possession of the envelope 220. To guide the envelope 220 through routing and delivery, the agency 240 transmits a request for decryption to said server 250 from a client computer 260, coupled with a scanner that reads the label. Conventional scanner hardware and software are used. The request could be transmitted over an internal or external computer network. In response, the agency 240's system decrypts said encrypted address with a private key, of said private-public encryption key pair, to yield said recipient's address. This is done as many times as necessary. In this example, the recipient's address in plaintext is not displayed and not used during routing and delivery, so the address is not visible to unauthorized observers. The system provides said recipient's address to a delivery person (not shown) via a client computer 270 (perhaps a handheld computer coupled with a scanner, for example) and network 230. Finally, the delivery person delivers the parcel or document to said recipient 280.

FIG. 3 is a block diagram illustrating in greater detail selected optional features that may be included in a system such as the exemplary system of FIG. 2, according to the teachings of the present invention. The left side of FIG. 3 shows a parcel or document 200 being prepared for delivery to a recipient 280 or recipient 380. Next, the encrypted address of recipient 280 or recipient 380 is displayed on envelope 220 as explained above, or the encrypted address of recipient 280 or recipient 380, along with an encrypted key, are displayed on envelope 320. This variation is a two-step process. First, the agency provides at least one symmetric encryption key (not shown) for recipient 280 or recipient 380, and encrypts said recipient's address with said symmetric key. Secondly, the agency provides at least one private-public encryption key pair (not shown) for recipient 280 or recipient 380, and encrypts said symmetric key with said public key. This two-step process may be preferred because it is faster to encrypt and decrypt data with a symmetric key.

This display of encrypted address on envelope 220, or display of encrypted data on envelope 320, could be accomplished by the sender or agency at step 310. Agency personnel may perform this function at a collection center, or mobile agency personnel may perform this function at a sender's address when picking up the envelope 220 or 320. Agency personnel or sender at step 310 use computer and printer 314 that could be mobile or stationary. The sender or agency at step 310 transmits a request for said encrypted data to said server 250 from a client computer with a printer, 314, over said computer network 230. The agency 240 transmits said encrypted address from said server 250 to said client computer and printer, 314, over said computer network 230, for printing on a label. The encrypted address is displayed on the envelope 220 by putting the label on the envelope 220. The encrypted data is displayed on the envelope 320 by putting the label on the envelope 320.

Next, the agency 240 takes possession of the envelope 220, or envelope 320. To guide the envelope 220 or envelope 320 through routing and delivery, the agency 240 transmits a request for decryption to said server 250 from a client computer 260. The request could be transmitted over an internal or external computer network. The system provides input to client computer 260 by coupling it with a scanner that reads data displayed on the envelope, including any identifier and encrypted data.

In response, the agency 240's system decrypts said encrypted address on envelope 220 with a private key, of said private-public encryption key pair, to yield said recipient's address. This is done as many times as necessary to guide the envelope 220 through routing and delivery. The system provides input to client computer 260 from server computer 250 over a computer network. The system provides output, including recipient's address, from client computer 260.

With an alternative method, regarding envelope 320, the agency 240's system decrypts the symmetric key with recipient's private key, then decrypts the recipient's address with the symmetric key.

If envelope 220, or envelope 320, follows the path of late decryption 395, the recipient's address in plaintext is not displayed and not used during routing and delivery, so the address is not visible to unauthorized observers. For routing the envelope at each stage, address decryption is performed without displaying the address on the envelope. This option is for a very high level of security. The system provides said recipient's address to a delivery person via a client computer 270 (perhaps a handheld computer coupled with a scanner, for example). Finally, the delivery person delivers envelope 220, or envelope 320, to said recipient 280.

If envelope 220, or envelope 320, follows the path of early decryption 390, the recipient's address in plaintext is put on the envelope within agency 240. After that step, the envelope is labeled 370 in FIG. 3. Client computer 260 outputs the recipient's address in plaintext for printing on a label. This label is put on envelope 370. The recipient's address in plaintext is used by agency personnel during routing and delivery, and is visible on envelope 370. This option offers a certain level of security, because the recipient need not make his or her address known to the sender or persons working with sender at step 310. Finally, the delivery person delivers envelope 370 to said recipient 380.

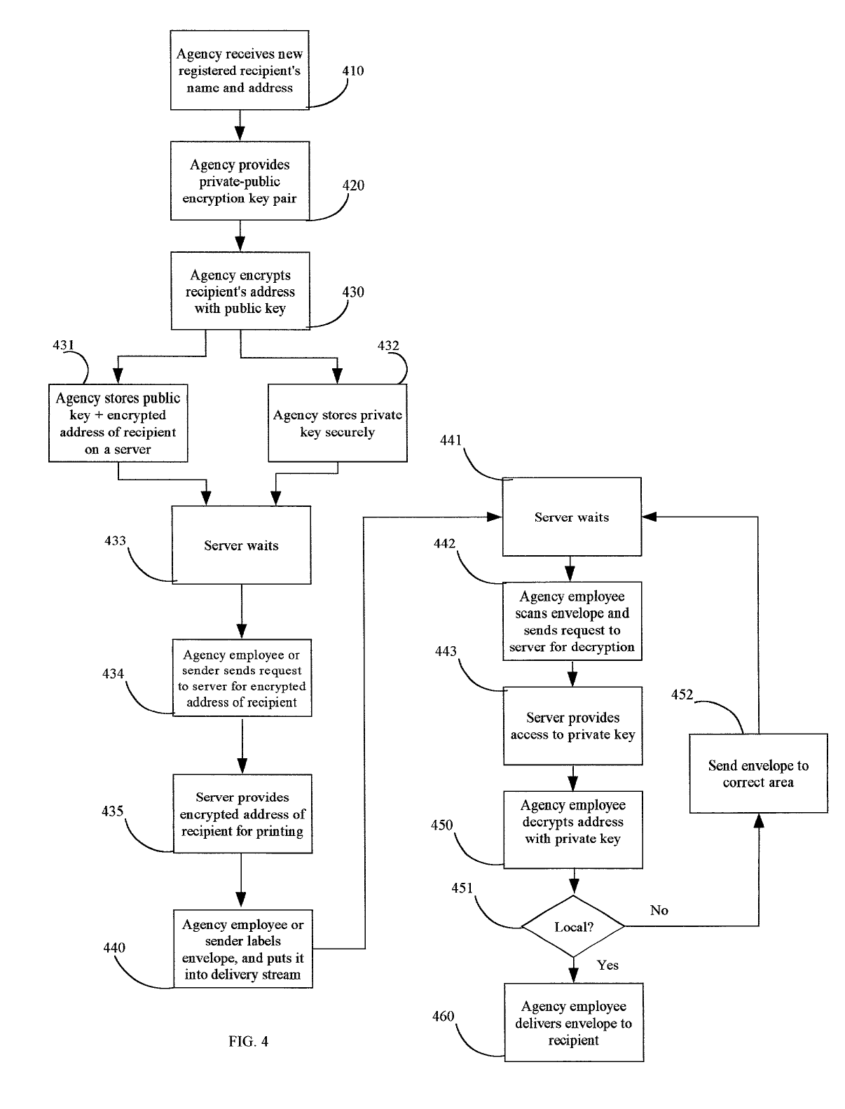

FIG. 4 is a flow chart illustrating in greater detail an exemplary process such as the exemplary process of FIG. 1, according to the teachings of the present invention. In this example the process starts at 410 with a delivery agency receiving a new registered recipient's name and address. Next, at 420, the agency provides at least one private-public encryption key pair for said recipient. (The recipient may choose to have different key pairs for different groups of senders.) The public key of a key pair is used to encrypt the recipient's address, 430.

The agency stores the public key and the encrypted address on a server, 431. After this step, the agency could provide the public key to a sender, who could encrypt the recipient's address if the sender knows the address. On the other hand, the agency could provide the recipient's encrypted address to a sender, and the sender would not need to know the recipient's address. The agency stores the private key securely, 432.

The server waits, 433, until an agency employee or sender transmits a request to the server for the encrypted address of the recipient, 434. In response, the server provides the encrypted address of the recipient for printing on a label, 435. The agency employee or sender puts the label on an envelope and puts the envelope into the agency's delivery stream, 440.

Next, the envelope is guided through routing and delivery as follows. A server (this may be a second server, separate from the one at step 433) waits, at 441, until an agency employee (or an automated process) scans or otherwise inputs the encrypted address of the recipient and transmits a request to the server for decryption, 442. With appropriate security conditions satisfied, the server provides access to the private key, 443. This access allows an agency employee (or an automated process) to decrypt the address with the private key, 450, and decide on the next step for proper handling of the envelope. If the recipient's address is not in the local area, the “No” branch is taken at decision 451 and the envelope is sent to the correct area for delivery, 452. If the recipient's address is in the local area, the “Yes” branch is taken at decision 451 and the envelope is delivered to the recipient, 460.

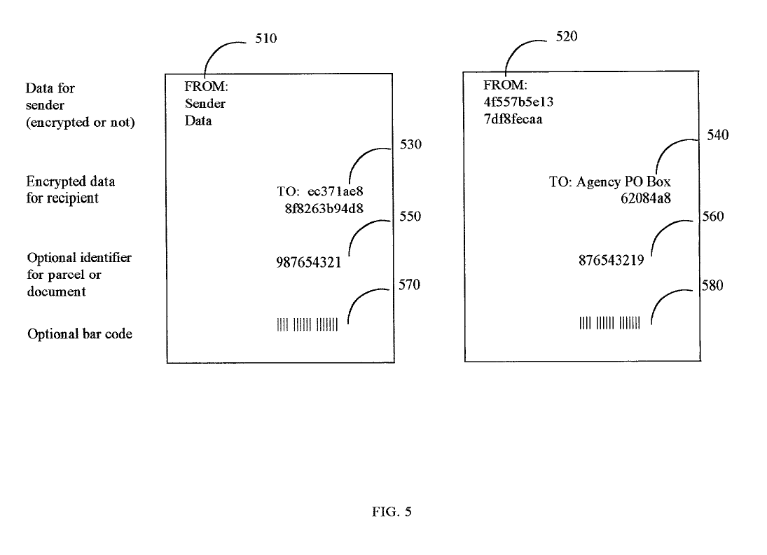

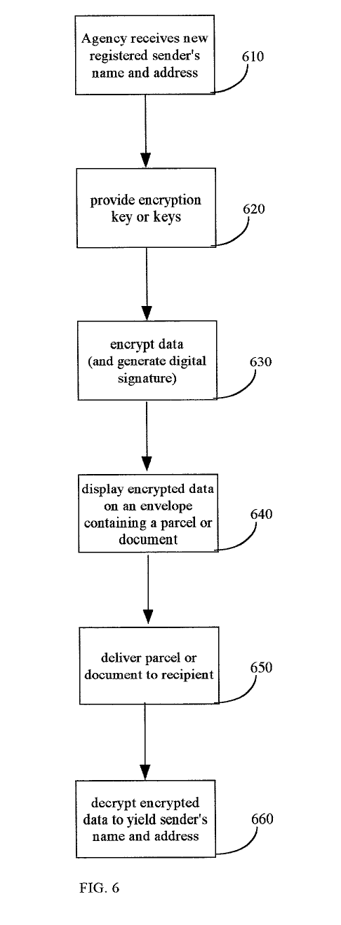

FIG. 5 is a diagram illustrating two examples of envelopes that could be used in a delivery process according to the teachings of the present invention. First, there is data for the sender, which may be encrypted or not, shown printed in the upper left part of each envelope. Data for the sender includes the sender's name and address, and possibly other data unique to the sender. An example of sender's data, not encrypted, is shown at 510. An example of sender's data, encrypted, is shown at 520. The option of encrypting a sender's data is further described below, regarding FIG. 6.

Next, there is encrypted data for the recipient. As described above regarding FIG. 3, the encrypted data may include the recipient's address, and possibly a symmetric key encrypted with a public key. Examples are shown at 530 and 540. The example at 530 shows the encrypted data presented as a string of characters. The example at 540 shows the encrypted data presented as a post office box number. However, the agency may decrypt the data to yield the recipient's physical address, and deliver the envelope to that physical address.

Next, examples of optional identifier numbers, not encrypted, are shown at 550 and 560. These may assist the agency in identifying or tracking the envelope, and selecting the proper key for decrypting data printed on the envelope. Finally, examples of optional bar codes are shown at 570 and 580. These may assist the agency in the same ways as the identifier numbers at 550 and 560.

FIG. 6 is a flow chart illustrating an example of a delivery process involving encrypting data unique to a sender (sender's data) according to the teachings of the present invention. In this example the process starts at 610 with a delivery agency receiving a new registered sender's name and address. Next, at 620, the agency provides encryption key or keys for the sender. For example, the agency may provide at least one private-public encryption key pair for said sender (sender's key pair). The key or keys are used to encrypt data for the sender, 630. For example, this step may involve encrypting data unique to the sender (sender's data, including the sender's name and address, and possibly other data unique to the sender) with a sender's private key, of said sender's key pair. When a sender is ready to send a parcel or document to recipient, at 640 the encrypted data is displayed on the envelope, in place of the sender's address in plaintext. This would be done at or before the time the agency takes possession of the envelope from the sender.

The next step is delivering said parcel or document to said recipient, 650. At that point, the agency's delivery person or the recipient may decrypt the encrypted sender's data, for example decrypting said encrypted sender's data with a sender's public key, of said sender's key pair, to yield the sender's name and address. This decryption step may yield other information as well, verifying who sent the parcel or document to the recipient. This authentication function is another feature of the present invention. In encrypting data unique to the sender, step 630 described above, a digital signature is generated. Decrypting the sender's data with a sender's public key, step 660, provides verification of the identity of the sender who sent the parcel or document to the recipient. There is abundant literature, including the above-cited references, about digital signatures as applied in other fields. The workings of digital signatures are well-known to those skilled in the art.

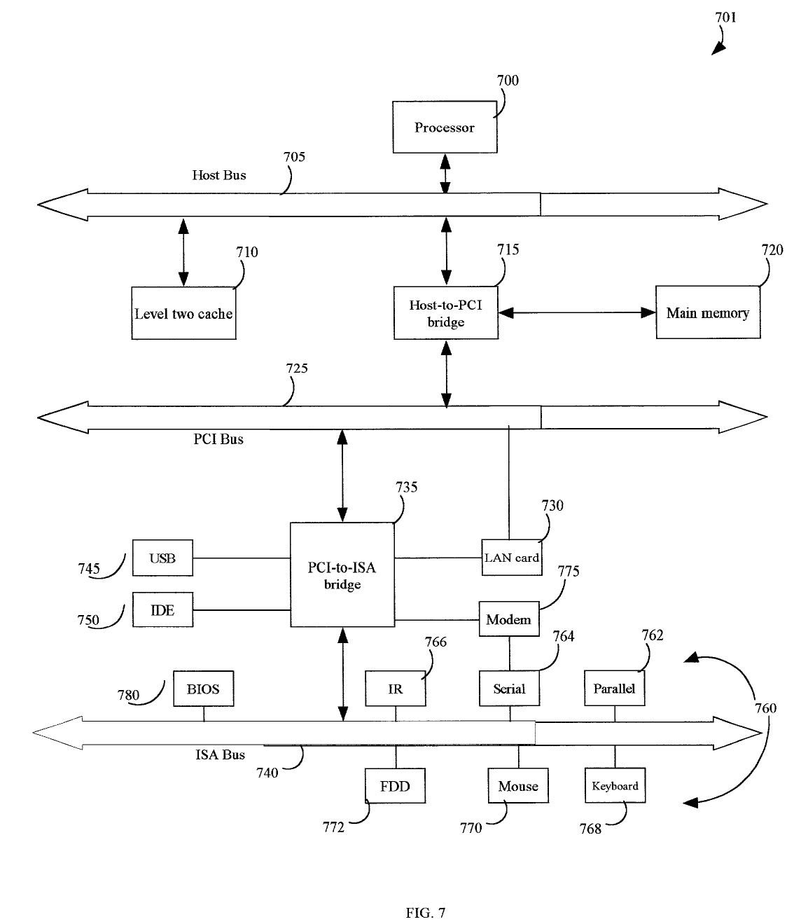

FIG. 7 illustrates information handling system 701 which is a simplified example of a computer system capable of performing the present invention. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, and can include other functional elements not shown, such as a real-time clock (RTC), DMA control, interrupt support, and system management bus support. Peripheral devices and input/output (I/O) devices can be attached to various interfaces 760 (e.g., parallel interface 762, serial interface 764, infrared (IR) interface 766, keyboard interface 768, mouse interface 770, and fixed disk (FDD) 772 coupled to ISA bus 740. Alternatively, many I/O devices can be accommodated by a super I/O controller (not shown) attached to ISA bus 740. BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to couple computer system 701 to another computer system over a network, LAN card 730 is coupled to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the processes described herein, this computer system is simply one example of a computer system. Those skilled in the art will appreciate that many other computer system designs are capable of performing the processes described herein.

One of the preferred implementations of the invention is an application, namely a set of instructions (program code) in a code module which may, for example, be resident in the random access memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the

While the invention has been shown and described with reference to particular embodiments thereof, it will be understood by those skilled in the art that the foregoing and other changes in form and detail may be made therein without departing from the spirit and scope of the invention. are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

I claim:

1. A method for secure delivery of a parcel or document from a sender to a recipient, said method comprising:
providing at least one private-public encryption key pair for said recipient;
encrypting data with a public key, of said private-public encryption key pair;
providing said encrypted data for display on an envelope containing said parcel or document;
decrypting said encrypted data with a private key, of said private-public encryption key pair, to yield said recipient's address, and
delivering said parcel or document to said recipient.

2. The method of claim 1, wherein said encrypting further comprises encrypting said recipient's address with said public key.

3. The method of claim 1, further comprising:
providing at least one symmetric encryption key for said recipient;
encrypting said recipient's address with said symmetric key; and
wherein said encrypting data with a public key further comprises encrypting said symmetric key with said public key.

4. The method of claim 1, wherein said encrypted data is displayed on said envelope by said sender.

5. The method of claim 1, wherein said encrypted data is displayed on said envelope by a delivery agency.

6.The method of claim 1, wherein said decrypting is done by a delivery person, shortly before delivery of said parcel or document.

7. The method of claim 1, wherein said decrypting is done by a delivery agency, shortly after receiving said parcel or document from said sender.

8. The method of claim 1, further comprising:
displaying an identifier of said parcel or document on said envelope, said identifier not being encrypted.

9. The method of claim 8, wherein said decrypting further comprises:
providing at least one client computer in communication with a computer network;
providing input of data displayed on said envelope to said client computer, including said identifier of said parcel or document, and said encrypted data;
providing input to said client computer from a server computer over said computer network; and
providing output from said client computer, including said recipient's address.

10. A method for secure delivery of a parcel or document from a sender to a recipient, said method comprising:
providing at least one symmetric encryption key for said recipient;
encrypting said recipient's address with said symmetric encryption key;
displaying said encrypted address on an envelope containing said parcel or document;
decrypting said encrypted address with said symmetric encryption key, to yield said recipient's address; and
delivering said parcel or document to said recipient.

11. The method of claim 10, wherein said encrypted address comprises a post office box number.

12. The method of claim 10, further comprising:
displaying an identifier of said parcel or document on said envelope, said identifier not being encrypted.

13. A method for secure delivery of a parcel or document from a sender to a recipient, said method comprising:
providing at least one server computer in communication with a computer network;
providing at least one private-public encryption key pair for said recipient;
encrypting data with a public key, of said private-public encryption key pair;
storing said encrypted data on said server;
receiving a request for said encrypted data from a client computer, over said computer network; and
transmitting said encrypted data from said server to said client computer, over said computer network, for display on an envelope containing said parcel or document.

14. A method for secure delivery of a parcel or document from a sender to a recipient, said method comprising:
providing at least one server computer in communication with a computer network;
providing at least one private-public encryption key pair for said recipient;
encrypting data with a public key, of said private-public encryption key pair;
transmitting a request for decryption to said server from a client computer, over said computer network;
decrypting said encrypted data with a private key, of said private-public encryption key pair, to yield said recipient's address;
providing said recipient's address to a delivery person via said client computer; and delivering said parcel or document to said recipient.

15. A method for secure delivery of a parcel or document from a sender to a recipient, said method comprising:
providing at least one private-public encryption key pair for said sender (sender's key pair);
encrypting data unique to said sender (sender's data) with a sender's private key, of said sender's key pair;
providing said encrypted sender's data for display on an envelope containing said parcel or document;
delivering said parcel or document to said recipient; and
decrypting said encrypted sender's data with a sender's public key, of said sender's key pair.

16. The method of claim 15, wherein:
said encrypting further comprises:
encrypting said sender's address; and
generating a digital signature; and
said decrypting further comprises verifying that said sender sent said parcel or document to said recipient.

17. A system for secure delivery of a parcel or document from a sender to a recipient, said system comprising:
means for providing at least one private-public encryption key pair;
means for encrypting data with a public key, of said private-public encryption key pair;
means for providing said encrypted data for display on an envelope containing said parcel or document; and
means for decrypting said encrypted data with a private key, of said private-public encryption key pair.

18. The system of claim 17, wherein said means for encrypting further comprises means for encrypting said recipient's address with said public key.

19. The system of claim 17, further comprising:
means for providing at least one symmetric encryption key for said recipient;
means for encrypting said recipient's address with said symmetric key; and
wherein said means for encrypting data with a public key further comprises means for encrypting said symmetric key with said public key.

20. The system of claim 17, wherein said encrypted data is displayed on said envelope by said sender.

21. The system of claim 17, wherein said encrypted data is displayed on said envelope by a delivery agency.

22. The system of claim 17, further comprising:
means for displaying an identifier of said parcel or document on said envelope, said identifier not being encrypted.

23. The system of claim 22, wherein said means for decrypting further comprises:
at least one client computer in communication with a computer network;
means for providing input of data displayed on said envelope to said client computer, including said identifier of said parcel or document, and said encrypted data;
means for providing input to said client computer from a server computer over said computer network; and
means for providing output from said client computer, including said recipient's address.

24. A computer-usable medium having computer-executable instructions for secure delivery of a parcel or document from a sender to a recipient, said computer-executable instructions comprising:
means for providing at least one private-public encryption key pair;
means for encrypting data with a public key, of said private-public encryption key pair;
means for providing said encrypted data for display on an envelope containing said parcel or document; and
means for decrypting said encrypted data with a private key, of said private-public encryption key pair.

25. The computer-usable medium of claim 24, wherein said means for encrypting further comprises means for encrypting said recipient's address with said public key.

26. The computer-usable medium of claim 24, further comprising:
means for providing at least one symmetric encryption key for said recipient;
means for encrypting said recipient's address with said symmetric key; and
wherein said means for encrypting data with a public key further comprises means for encrypting said symmetric key with said public key.

27. The computer-usable medium of claim 24, wherein said encrypted data is displayed on said envelope by said sender.

28. The computer-usable medium of claim 24, wherein said encrypted data is displayed on said envelope by a delivery agency.

29. The computer-usable medium of claim 24, further comprising:
means for displaying an identifier of said parcel or document on said envelope, said identifier not being encrypted.

30. The computer-usable medium of claim 29, wherein said means for decrypting further comprises:
means for providing input of data displayed on said envelope to a client computer in communication with a computer network, including said identifier of said parcel or document, and said encrypted data;
means for providing input to said client computer from a server computer over said computer network; and
means for providing output from said client computer, including said recipient's address.
